(19) United States
(12) Patent Application Publication
(10) Pub. No.: US 2013/0316764 A1
(43) Pub. Date: Nov. 28, 2013

(54) MULTIPLE SIM FREQUENCY CONTROL SYSTEM

(71) Applicants: Rami Mehio, San Diego, CA (US); Jin-Sheng Su, San Diego, CA (US)

(72) Inventors: Rami Mehio, San Diego, CA (US); Jin-Sheng Su, San Diego, CA (US)

(73) Assignee: Broadcom Corporation, Irvine, CA (US)

(21) Appl. No.: 13/480,188

(22) Filed: May 24, 2012

(51) Int. Cl. H04W 4/00

(52) U.S. Cl. 455/558

(57) ABSTRACT

A frequency control system enhances user equipment performance. The user equipment may include multiple SIMs, and the frequency control system may facilitate successful background page monitoring for a SIM that is not currently active. In particular, the frequency control system may track environmental factors that influence time base accuracy in the user equipment. When the background page monitoring activity happens for the inactive SIM, the frequency control system may apply a correction to the time base that facilitates successful reception of the paging indicators for the inactive SIM.

### 1. TECHNICAL FIELD

This disclosure relates to communication devices with multiple Subscriber Identity Modules (SIMs). The disclosure also relates to frequency control in the radio frequency (RF) interface in communication devices with multiple SIMs.

### 2. BACKGROUND

Rapid advances in electronics and communication technologies, driven by immense customer demand, have resulted in the widespread adoption of mobile communication devices. The extent of the proliferation of such devices is readily apparent in view of some estimates that put the number of wireless subscriber connections in use around the world at nearly 80% of the world's population. Furthermore, other estimates indicate that (as just three examples) the United States, Italy, and the UK have more mobile phones in use in each country than there are people living in those countries.

Relatively recently, cellular phone manufactures have introduced phone designs that include multiple SIM cards. Each SIM card facilitates a separate connection to the same network or different networks. As a result, the SIMs provide the owner of the phone with, for example, two different phone numbers handled by the same phone hardware. Accordingly, the multiple SIM approach alleviates to some degree the need to carry different physical phones, and improvements in multiple SIM communication devices will continue to make such devices attractive options for the consumer.

### BRIEF DESCRIPTION OF THE DRAWINGS

The innovation may be better understood with reference to the following drawings and description. In the figures, like reference numerals designate corresponding parts throughout the different views.

FIG. 1 shows an example of user equipment with multiple SIMs.

FIG. 2 shows an example of a radio frequency (RF) control logic and baseband control logic.

FIG. 3 shows a temperature-frequency response characteristic.

FIG. 4 shows an example of two SIMs alternating access to the RF communication interface.

FIG. 5 shows an example of two SIMs alternating access to the RF communication interface and parameters that may affect oscillator frequency.

FIG. 6 shows an example of applying correction values to frequency settings.

FIG. 7 shows an example of applying correction values to frequency settings.

FIG. 8 shows an example of determining correction values using a choice of parameters.

FIG. 9 is an example of logic for frequency control.

### DETAILED DESCRIPTION

The discussion below makes reference to user equipment. User equipment may take many different forms and have many different functions. As one example, user equipment may be a cellular phone capable of making and receiving wireless phone calls. The user equipment may also be a smartphone that, in addition to making and receiving phone calls, runs general purpose applications. User equipment may be virtually any device that wirelessly connects to a network, including as additional examples a driver assistance module in a vehicle, an emergency transponder, a pager, a satellite television receiver, a networked stereo receiver, a computer system, music player, or virtually any other device. The discussion below addresses how to manage paging reception in user equipment that includes multiple (e.g., two) SIMs.

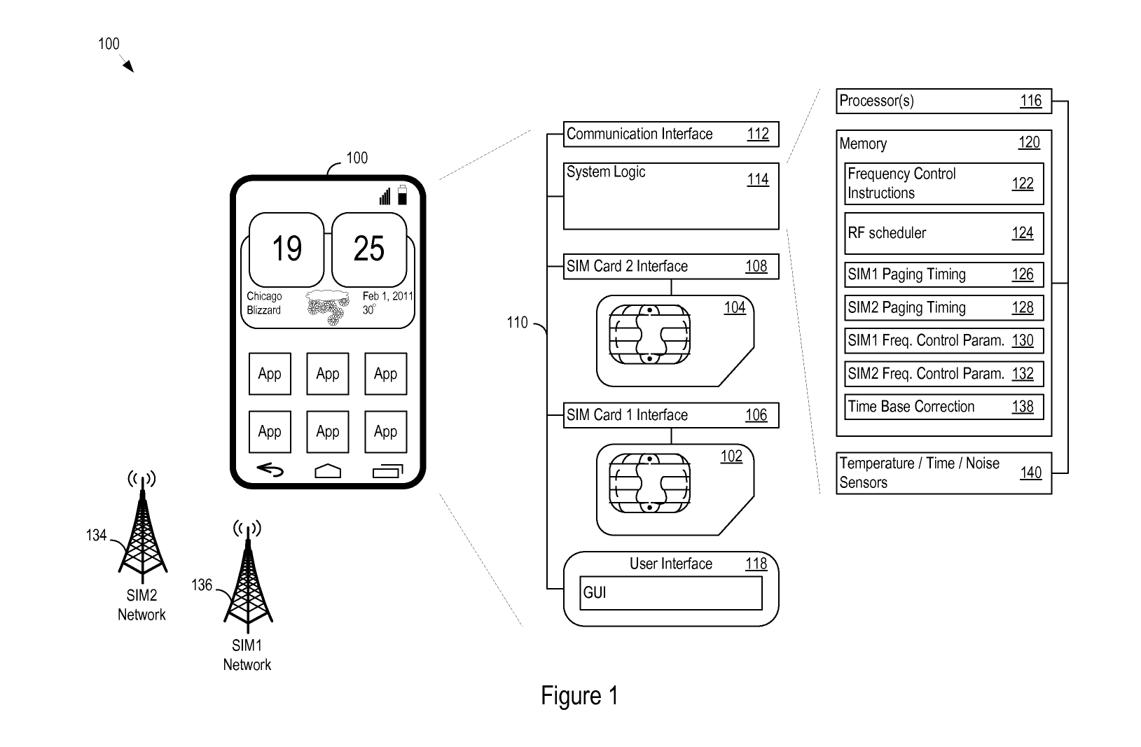

FIG. 1 shows an example of user equipment 100 with multiple SIMs, in this example the SIM1 102 and the SIM2 104. An electrical and physical interface 106 connects SIM1 102 to the rest of the user equipment hardware, for example, through the system bus 110. Similarly, the electrical and physical interface 108 connects the SIM2 to the system bus 110.

The user equipment 100 includes a communication interface 112, system logic 114, and a user interface 118. The system logic 114 may include any combination of hardware, software, firmware, or other logic. The system logic 114 may be implemented, for example, in a system on a chip (SoC), application specific integrated circuit (ASIC), or other circuitry. The system logic 114 is part of the implementation of any desired functionality in the user equipment. In that regard, the system logic 114 may include logic that facilitates, as examples, running applications, accepting user inputs, saving and retrieving application data, establishing, maintaining, and terminating cellular phone calls, wireless network connections, Bluetooth connections, or other connections, and displaying relevant information on the user interface 118. The user interface 118 may include a graphical user interface, touch sensitive display, voice or facial recognition inputs, buttons, switches, and other user interface elements.

The communication interface 112 may include one or more transceivers. The transceivers may be wireless transceivers that include modulation/demodulation circuitry, digital to analog converters, analog to digital converters, filters, waveform shapers, amplifiers and/or other logic for transmitting and receiving through one or more antennas, or through a physical (e.g., wireline) medium. As one implementation example, the communication interface 112 and system logic 114 may include a BCM2091 EDGE/HSPA Multi-Mode, Multi-Band Cellular Transceiver and a BCM59056 advanced power management unit (PMU), controlled by a BCM28150 HSPA+ system-on-a-chip (SoC) baseband smartphone processer or a BCM25331 Athena™ baseband processor. These integrated circuits, as well as other hardware and software implementation options for the user equipment 100, are available from Broadcom Corporation of Irvine Calif.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interface 112 may support transmission and reception under the Universal Mobile Telecommunications System (UMTS). The techniques described below, however, are applicable to other communications technologies that include paging whether arising from the 3rd Generation Partnership Project (3GPP), GSM (R) Association, Long Term Evolution (LTE)™ efforts, or other partnerships or standards bodies.

In one implementation, the system logic 114 includes one or more processors 116 and a memory 120. The memory 120 stores, for example, frequency control instructions 122 that the processor 116 executes. The memory 120 may include an RF scheduler 124. The RF scheduler 124 may determine when in time each of the SIM1 102 and SIM2 104 will access the radio frequency resources so that SIM1 102 and SIM2 104 may transmit or receive data. In some implementations, SIM1 102 and SIM2 104 share a common RF transmit or receive path in the communication interface 112. The RF scheduler 124 may then allow SIM 102 and SIM2 104 time division access to the RF path, as both SIM1 102 and SIM2 104 cannot both be active on the RF interface at the same time. As one specific example, the RF scheduler 124 may read the SIM1 paging timing parameters 126 and the SIM2 paging parameters 128, and schedule RF resource access according to when the paging indicators are expected to be transmitted for either SIM.

In that regard, the RF scheduler 124 may determine the timing of paging indicators transmitted by the Node B 136, which may generate the cell to which SIM1 102 connects, and the Node B 134, which may generate the cell to which SIM2 104 connects (for example). Each paging indicator has a position ‘q’ within a paging indicator channel (PICH). The RF scheduler 124 determines the position ‘q’ of the paging indicators using information supplied by the Node B 134 and the Node B 136. In that regard, the networks supported by the Node Bs may configure the user equipment 100 to start listening for paging indicators and provide all or part of the information for determining the position ‘q’. An example of the determination that the RF scheduler 124 may implement is provided in section 5.3.3.10 of V8.7.0 of the 3GPP technical specification for group radio access network.

As will be described in more detail below, the frequency control instructions 122 provide enhanced frequency control over the radio frequency (RF) interface. To that end, the frequency control instructions 122 may store and retrieve frequency control parameters for the SIMs. For example, the frequency control instructions 122 may store a SIM1 automatic frequency control (AFC) parameter 130, and a SIM2 AFC parameter 132. The parameters 130 and 132 may, for example, tune the frequency output of an oscillator in the communication interface 112 that establishes a transmit or receive frequency for the network that SIM1 102 communicates with or that SIM2 104 communicates with. Each SIM may transmit or receive on different frequencies and may be in communication with the same or different networks. In some implementations, the parameters 130 and 132 include a coarse correction value, a fine correction value, or other values.

The SIMs may be in active modes (e.g., a network connection is established for active data transfer for the SIM) or in idle modes (e.g., there is no network connection established, and the SIM is camped on the network). When there is a single RF path, one SIM may be in active mode at any given time. Despite one SIM being active, the RF scheduler 124 may schedule time to receive on the correct frequency for the idle SIM, to receive data for the idle SIM. In particular, the RF scheduler 124 may schedule time to receive paging indicators for the idle SIM in an effort to identify incoming connections (e.g., voice calls).

As a specific example, the SIM1 102 may be active, having established a packet switched data connection with the Node B 134. At predetermined times during the network connection for the active SIM, the Node B 136 will transmit paging indicators for SIM2 104, the inactive SIM. The RF scheduler 124 may attempt to receive any one or more of the paging indicators for SIM2 104. To do so, the RF scheduler 124 will switch the communication interface 112 to receive on the frequency assigned to the network supporting the SIM2 104. This may temporarily interrupt communication over the active network connection for SIM1 102. The switch may be brief—long enough to receive the paging indicator for SIM2 104, after which the RF scheduler 124 returns the communication interface 112 to the transmit/receive frequency pair for the network supporting SIM1 102. After switching back to SIM1 102, the communications may continue for the already established and active SIM1 102 network connection, and data or control messages lost during the switch to SIM2 104 may be retransmitted.

As will also be described in more detail below, the frequency control instructions 122 may determine one or more time base corrections 138 for either SIM. For example, when the SIM1 releases the RF to SIM2, the frequency control instructions 122 may store the SIM1 frequency control parameter 130 and retrieve a previously saved SIM2 frequency control parameter 132. The previously saved frequency control value may be the immediately previous value for SIM2 or a value prior to that. The frequency control instructions 122 use the SIM2 frequency control parameter 132, saved during a prior switch from SIM2 to SIM1, to set the proper receive frequency for the network that SIM2 104 connects to, using the frequency control logic in the communication interface 122. In addition to restoring the receive frequency for SIM2 104, the frequency control instructions 122 may determine and apply a time base correction 138 to the previously saved SIM2 frequency control parameter 132, when switching from SIM1 102 to SIM2 104 on the RF interface, or to the SIM1 frequency control parameter 130, when switching from SIM2 104 to SIM1 102 on the RF interface.

The time base correction 138 adjusts the output of, for example, a time base (e.g., a crystal oscillator) in the communication interface 112 so that the output frequency is compensated for temperature, aging, noise, Doppler shift, or any other environmental effect that may have arisen since the time that the frequency control parameters 130 and 132 were saved. Without the time base correction 138, the restored frequency control parameters 130 and 132 may later result in a different frequency for reception in the communication interface 112 than when the frequency control parameters 130 and 132 were saved. The wrong frequency (resulting, for example, because the crystal oscillator has heated during the active SIM connection and since the last inactive SIM connection) may make it difficult or impossible to recover data for the inactive SIM. The frequency control instructions 122 may obtain readings of environmental data at any point in time or over at multiple points in time from the temperature, time, GPS, speed, and noise sensors 140 to help determine the time base correction 138.

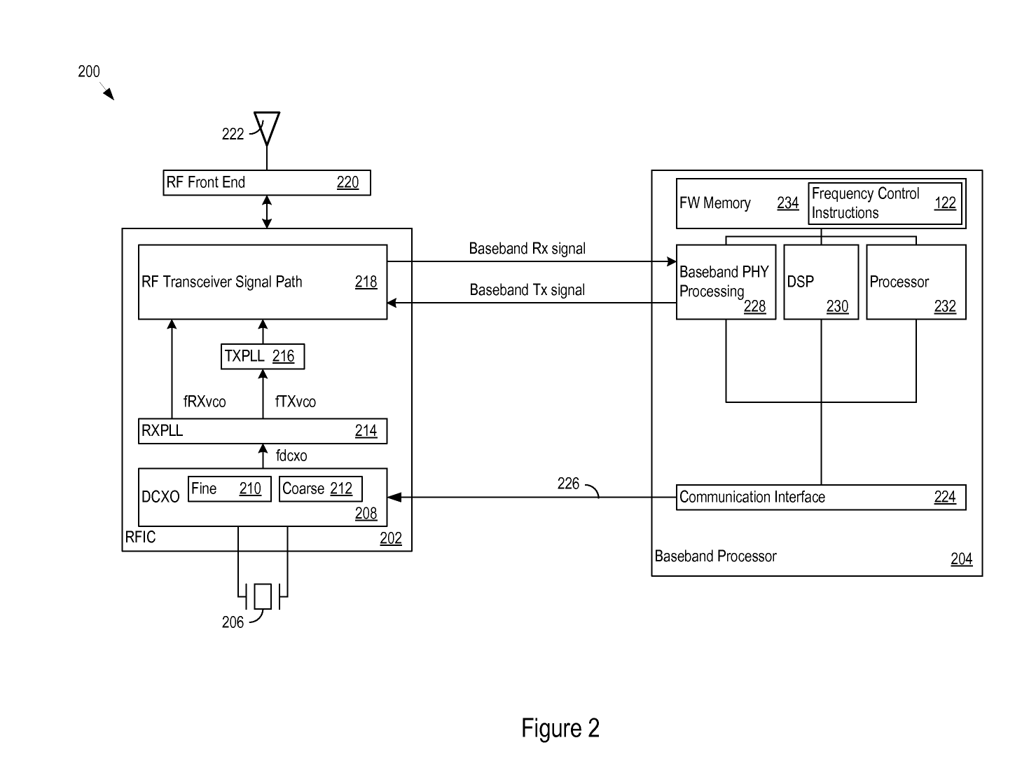

FIG. 2 shows an implementation example 200 of the user equipment communication interface 112 and system logic 114. The implementation example includes radio frequency (RF) control logic 202 and baseband control logic 204. The RF control logic 202 may be, for example, a Broadcom BCM2091 EDGE/HSPA Multi-Mode, Multi-Band Cellular Transceiver. The baseband control logic 204 may be, as examples, a BCM28150 HSPA+ system-on-a-chip (SoC) baseband smartphone processer or a BCM25331 Athena™ baseband processor.

FIG. 2 shows that a time base 206, in this instance a crystal oscillator, connects to the RF control logic 202. In particular, the time base 206 connects to digitally controlled crystal oscillator logic (DCXO) 208. The DCXO 208 may include circuitry that tunes the frequency output of the time base 206. For example, the DCXO 208 may include capacitor banks that are programmable through frequency control registers and that adjust the capacitive loading on the time base 206 to influence its frequency output. In the example shown in FIG. 2, the DCXO 208 includes a fine frequency control register 210 that may adjust the time base 206 output by plus or minus 80 ppm, with, for example, 14 bit resolution. Larger adjustments may be implemented by writing to the coarse frequency control register 212 that may adjust the time base 206 output by plus or minus 120 ppm with, for example, 6 bit resolution. The coarse frequency control register 212 may pull the oscillator frequency to the middle of a desired range (e.g., for a particular crystal oscillator), from which the fine frequency control register 210 may fine tune the frequency. Other devices may have different frequency control logic adjustable over different ranges.

The DCXO 208 produces the output frequency fdcxo to a receive (RX) phase locked loop (PLL) 214. The RX PLL 214 generates the RX frequency fRXvco and the transmit (TX) frequency fTXvco. These two frequencies may be separated by a fixed frequency offset determined by any particular network with which network connections for the SIMs are made. The TX PLL 216 provides further control over the TX frequency. Both the RX frequency fRXvco and the TX frequency fTXvco are provided to the RF transceiver signal path 218. The RF transceiver signal path 218 includes the modulators, demodulators, intermediate frequency mixers, encoders, decoders, and other RF path logic for transmitting data through the RF front end 220 and the antenna 222. The RF front end 220 may include a power amplifier, low noise amplifier, or other circuitry for driving a signal out of the antenna 222 or receiving a signal from the antenna 222.

The baseband control logic 204 communicates with the RF control logic 202 through the communication interface 224. The communication interface 224 may be a serial or parallel interface to a bus 226, such as an IIC bus or SPI bus, as examples. The baseband control logic 204 may also include baseband physical (PHY) processing logic 228, a digital signal processor 230, a host processor 232, or any other processing logic, among which any particular processing tasks are allocated. Any of the processing logic may execute instructions from one or more firmware memories 234, including the frequency control instructions 122.

The baseband control logic 204 (e.g., under control of the frequency control instructions 122), may write frequency control values into the fine frequency control register 210 and the coarse frequency control register 212 through the communication interface 224. The frequency control values set the output frequency fdcxo, and therefore set the transmit and receive frequencies. More particularly, the frequency control values set the output frequency by adjusting the nominal frequency of the time base 206. As one example, the nominal frequency may be 32 KHz.

The nominal frequency changes with changes in the environment, including temperature, voltage, noise, Doppler shift, age of the time base, and other factors. In one implementation, the system logic 114 stores frequency response characteristics that characterize how the nominal frequency changes with any particular environmental characteristic. As one particular example, the frequency response characteristic may be a temperature-frequency response characteristic for a crystal oscillator. Then, then the frequency control instructions 122 may determine the time base correction by locating the temperature on the temperature-frequency response characteristic.

One way to describe the implementation example 200 is that the system includes radio frequency (RF) control logic 202 with an oscillator frequency adjustment registers (210, 212), a RF receive path 218 configured to receive RF signals on a frequency responsive to the oscillator frequency adjustment register(s), and baseband control logic 204. The baseband control logic 204 includes a communication interface 224 to the radio frequency control section 202, one or more processors (228, 230, 232), and memory 234 in communication with the processor. The memory 234 includes frequency control instructions 122 configured to: a) monitor an environmental parameter while a first SIM network connection is established for an active SIM; b) determine a time base correction from the environmental parameter; c) obtain a previously saved time base frequency control parameter; d) obtain a new time base control parameter from the previously saved time base frequency control parameter and the time base correction; e) and communicate the new time base control parameter to the RF control logic 202 through the communication interface 224 prior to an attempt to receive data for an inactive SIM.

The data may be a paging indicator. The first SIM network connection may be a packet switched data connection, a circuit switched voice call, or another type of network connection. The environmental parameter may be temperature, aging, noise, system voltage or time base voltage, Doppler shift, or other parameters. Furthermore, the memory 234 may store a temperature-frequency response characteristic for an oscillator connected to the RF control logic 202. The frequency control instructions 122 may determine the time base correction by locating the temperature, and a corresponding expected frequency error, on the temperature-frequency response characteristic. Given the expected frequency error, the frequency control instructions 122 may determine the time base correction value that compensates for the expected frequency error in the DCXO 208. Furthermore, the frequency control instructions may also save the new time base control parameter prior to continuing communication on the first SIM network connection, and on a subsequent interruption of the first SIM network connection to attempt to receive data for the inactive SIM, retrieve the new time base control parameter for use as the previously saved time base frequency control parameter.

More generally, the frequency control instructions 122 may determine the time base correction as any function of environmental parameters over time. As one example, SIM2 104 may go inactive and SIM1 102 may become active at time A, and the RF scheduler 124 may schedule a paging indicator reception later at time B for inactive SIM2 104. The frequency control instructions 122 may then determine:

time base correction=f(A,B);

Where f is a function that maps environmental parameters over the time span from A to B to a time base correction value. As one specific example, the function may take the temperature at time B or the difference in temperature between time A and time B, and determine the expected frequency error due to the temperature or temperature difference. The time base correction may be applied to a previously saved (e.g., at time A) frequency control parameter for SIM2 104 that would cause frequency error if it were simply restored to the DCXO 208 without correction. From the expected frequency error, the function may determine the corresponding time base correction value, adjust the previously saved frequency control parameter value for the SIM2 104 to obtain a new time base control parameter for the SIM2 104, and communicate the new time base control parameter to the DCXO 208. The new time base frequency control parameter (e.g., the parameters 130 or 132) may include a coarse correction value, a fine correction value, or other settings to control frequency (e.g., in a DCXO). In other implementations, the DCXO 208 may not distinguish between coarse or fine control, but may include a general purpose control register or other controllable logic that compensates for expected time base frequency output errors.

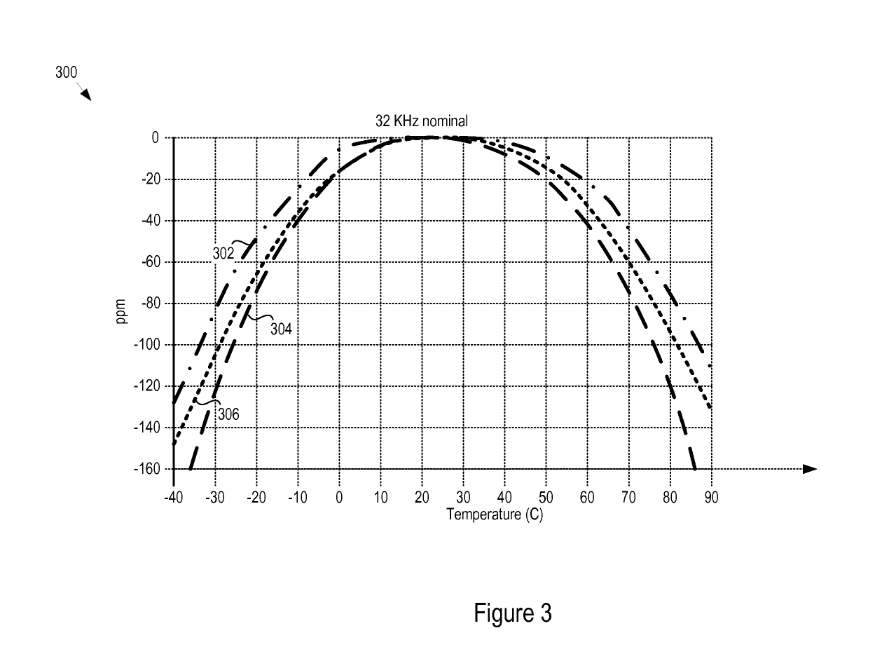

FIG. 3 shows example temperature-frequency response characteristics 300 that illustrate how the frequency output changes with temperature for three example crystals, each with a nominal 32 KHz frequency output. In particular, the response curve 302 shows how the frequency output varies for a first example crystal over temperature. For example, at −20 degrees C., the frequency output can be expected to be about −50 ppm different from 32 KHz. Similarly, the frequency response curves 304 and 306 illustrate how the nominal frequency output is expected to vary over temperature for second and third crystals, respectively. The system logic 114 may store any number of such characteristics in memory for any number of different environmental parameters.

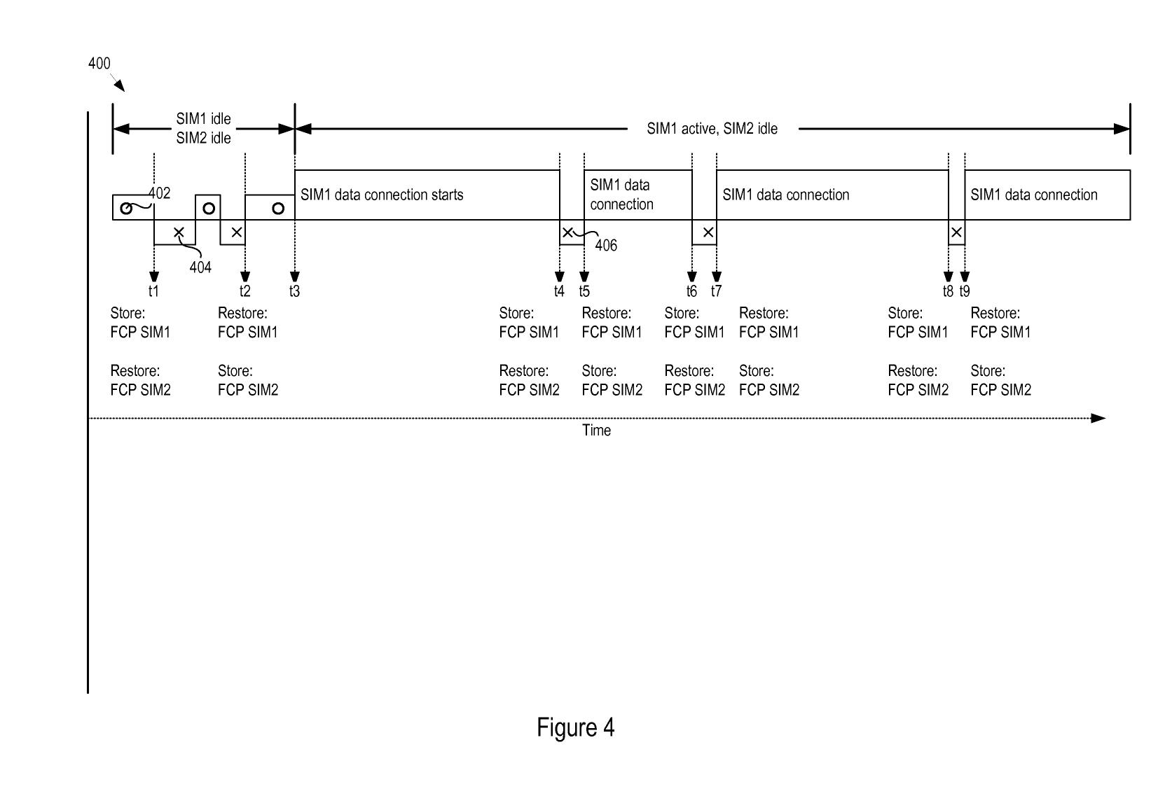

FIG. 4 shows an example timing diagram 400 of two SIMs alternating access to the RF communication interface 112. In the example in FIG. 4, SIM1 102 and SIM2 104 are initially both in idle mode. While in idle mode, the RF scheduler 124 performs background page monitoring. To that end, the RF scheduler 124 permits time division access to the communication interface 112, for example at time t1 for SIM2 104 and time t2 for SIM1 102. During the time division access for SIM1 102, the user equipment 100 receives paging indicators as scheduled by the Node B 136 for SIM1 102 and determines whether a paging indicator is set for SIM1 102. Similarly, during the time division access for SIM2 104, the user equipment 100 receives paging indicators as scheduled by the Node B 134 for SIM2 104 and determines whether a paging indicator is set for SIM2 104.

When both SIMs are in idle mode, the amount of time spent to check for a paging indicator may be small, and environmental characteristics (e.g., temperature) may not change significantly. As a result, using a previously saved value for the frequency control parameter when switching between reception of SIM1 102 paging indicators and SIM2 104 paging indicators may not lead to difficulties receiving the paging indicators. However, the frequency control instructions 122, in some implementations, may also determine time base correction values for the frequency control parameters when both SIMs are in idle mode, particularly if environmental factors are expected to change during background page monitoring.

At time t3, SIM1 102 enters active mode for a data connection. Nevertheless, the RF scheduler 124 schedules time to attempt to receive paging indicators for SIM2 104. Several examples of attempts to receive paging indicators for SIM2 104 are present in FIG. 3 at times t4, t6, and t8.

As noted above, the network connections for the SIMs typically specify different transmit and receive frequencies for the network connections. For that reason, the frequency control instructions 122 may save the frequency control parameter (FCP) for SIM1 102 when RF access switches to SIM2 104, and save the frequency control parameter for SIM2 104 when RF access switched to SIM1 102. The previously saved frequency control parameters are retrieved and restored to the DCXO 208 when access returns to a particular SIM. FIG. 4 shows several examples of the store/restore pattern.

Taking a specific example, at time t4, the frequency control instructions 122 save the FCP for SIM1 102 and restore the FCP for SIM2 104. The RF scheduler 124 schedules a brief interruption of the network connection for SIM1 102 and attempts to receive the paging indicator 406 for SIM2 104. At time t5, the frequency control instructions 122 store the FCP for SIM2 104 and restore the FCP for SIM1 102. The RF scheduler 124 then resumes the SIM1 data connection. FIG. 4 shows one example access pattern to the RF, and is used in further examples below, but of course any particular access pattern is applicable. Also, SIM2 104 may be the active SIM and SIM1 102 may be the idle SIM for which paging indicators are received by interrupting SIM2 104.

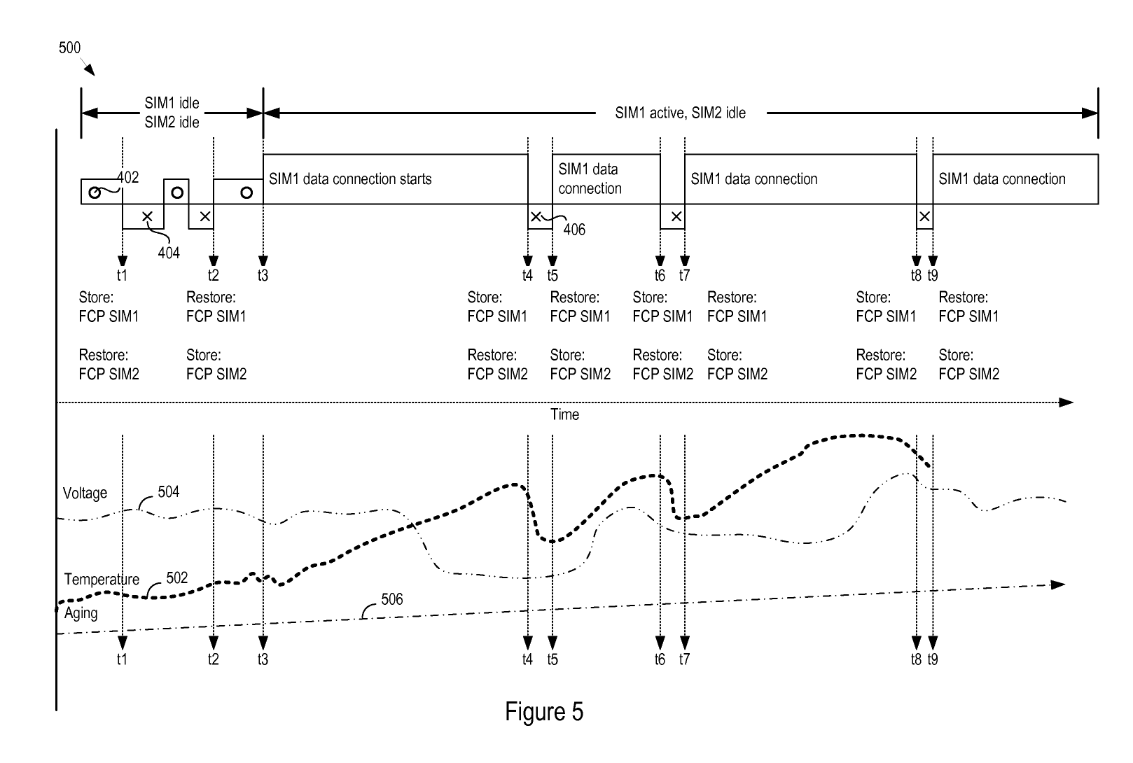

FIG. 5 shows a timing diagram 500 of two SIMs alternating access to the RF communication interface. FIG. 4 also shows several example parameters that may affect oscillator frequency: temperature 402, voltage 404, and aging 406. There may be fewer, additional, or different parameters, such as system noise, Doppler shift, or oscillator current that the sensors 140 measure and that the frequency control instruction 122 compensate.

The temperature 402 may be a temperature measured at any particular point in the user equipment 100. For example, the temperature may be the temperature of the RF control logic 202, the baseband control logic 204, or the temperature of the case containing the logic 202 and 204. As additional examples, the temperature may be the temperature of a component of the user equipment 100 such as the crystal 206, DAC, ADC, filter, amplifier, or other component, the temperature of the processor 116 or memory 120, or another component. Temperature effects can cause the frequencies produced by the time base 206 to drift or otherwise become inaccurate. The system logic 114 may communicate with one or more temperature sensors 120 to obtain temperature readings from any part of the user equipment 100.

The voltage 404 may be a voltage measured at any particular point in the user equipment 100. The voltage 404 may be a bias or power supply voltage applied to a crystal oscillator, for example. As another example, the voltage 404 may be the voltage produced by a voltage regulator for the processor 116, memory 120, or any other component of the user equipment 100. As with temperature variations, voltage variation may also cause drift or other inaccuracies in the frequencies produced by the time bases in the user equipment 100. The system logic 114 may communicate with one or more voltage sensors 120 to obtain temperature readings from any part of the user equipment 100.

Aging 406 is another example of an effect that may cause variation in time base output, leading to frequency errors. Aging may happen slowly over time, or may be accelerated due to temperature and other environmental effects. An aging sensor (e.g. a timer) in the sensors 120 may keep track of the age of the oscillator, for example so that the frequency control instructions 122 can compensate for frequency error due to aging.

Continuing the example shown in FIG. 4, the temperature 402 stays about the same while the SIMs are in idle mode, because the RF is relatively inactive, and the time spent to check for paging indicators is relatively brief. However, at time t3, SIM1 102 establishes a network connection for a data connection, and the temperature rises significantly as SIM1 102 remains active on the RF interface. The rise in temperature may be due to amplifiers and other logic actively transmitting and receiving for the data connection. As a result, there may be a substantial difference in temperature at different points in time, such as at the start of SIM1 access, t3, and to the start of SIM2 access, t4. The rise in temperature causes the frequency output of the time base 206 to drift. Accordingly, simply restoring, at time t4, the previously saved FCP for SIM2 may result in an inaccurate receive frequency for receiving the paging indicator for SIM2 104 at time t4. A similar rise in temperature happens as the data connection continues between t5 and t6, and between t7 and t8. Frequency errors may therefore also be present at times t6 and t8 when the user equipment 100 also attempts to receive paging indicators for SIM2 104.

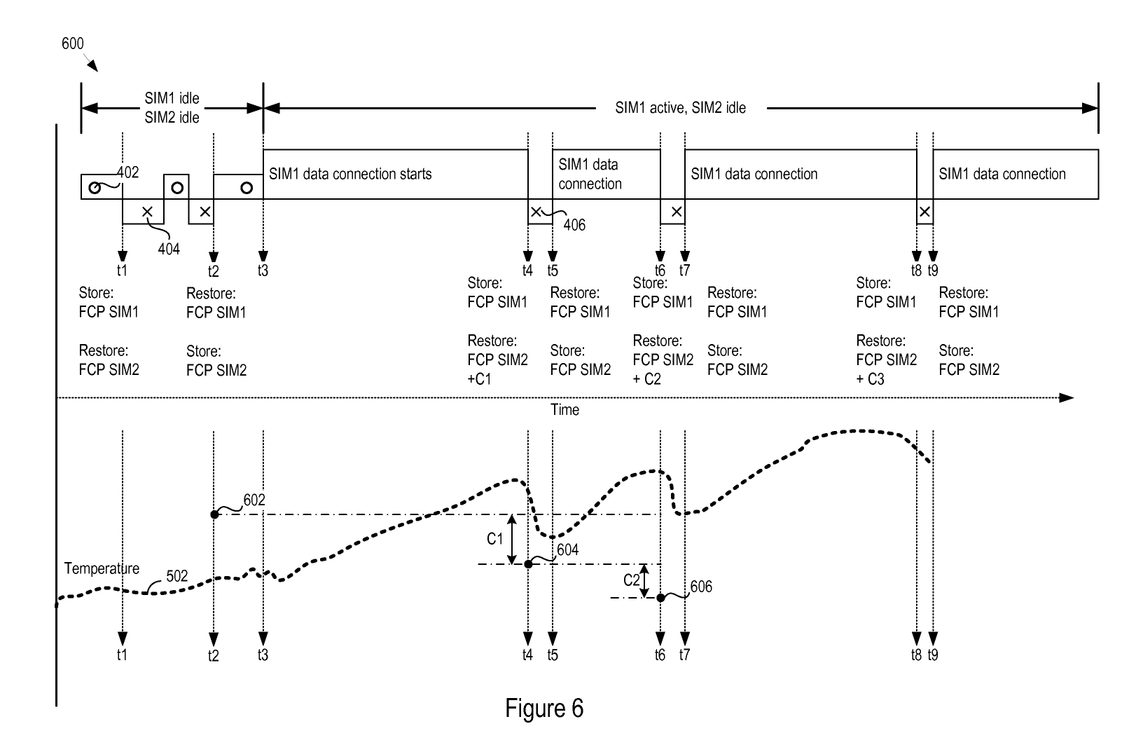

FIG. 6 shows an example 600 of applying a time base correction to frequency control parameters. As noted above, various parameters such as temperature, voltage, and aging may affect oscillator accuracy. As a result, simply restoring a prior frequency control parameter may not result in the same frequency output that the same frequency control parameter generated at a prior time (e.g., when temperature was lower). For that reason, the frequency control instructions 122 may determine a time base correction based on parameters that affect oscillator accuracy. The system logic 114 may apply the time base correction to the previously saved frequency control parameter retrieved in an attempt to compensate for parameters such as temperature, voltage, and aging.

As an example, in FIG. 6 at time t4, the frequency control instructions 122 determine and apply the time base correction C1 to the previously stored frequency control parameter 602 for SIM2 104. The time base correction C1 may compensate for the change in temperature while SIM1 was active, e.g., between time t3 and time t4, for example. Alternatively, the time base correction C1 may compensate for the change in temperature between the last time that the frequency control parameter for SIM2 104 was saved, time t2, and when the frequency control parameter for SIM2 104 needs to be restored, at time t4. The adjusted frequency control parameter provides a new frequency control parameter 604 for SIM2 104 that the frequency control instructions 122 communicate to the DCXO 208 for controlling the receive frequency between times t4 and t5. The frequency control instructions 122 may store the new frequency control parameter 604 at time t5, when the network connection for SIM1 102 continues. A time base correction, C2, also happens at time t6, resulting in a new frequency control parameter 606 for SIM2 104, and at time t8, shown as the time base correction C3.

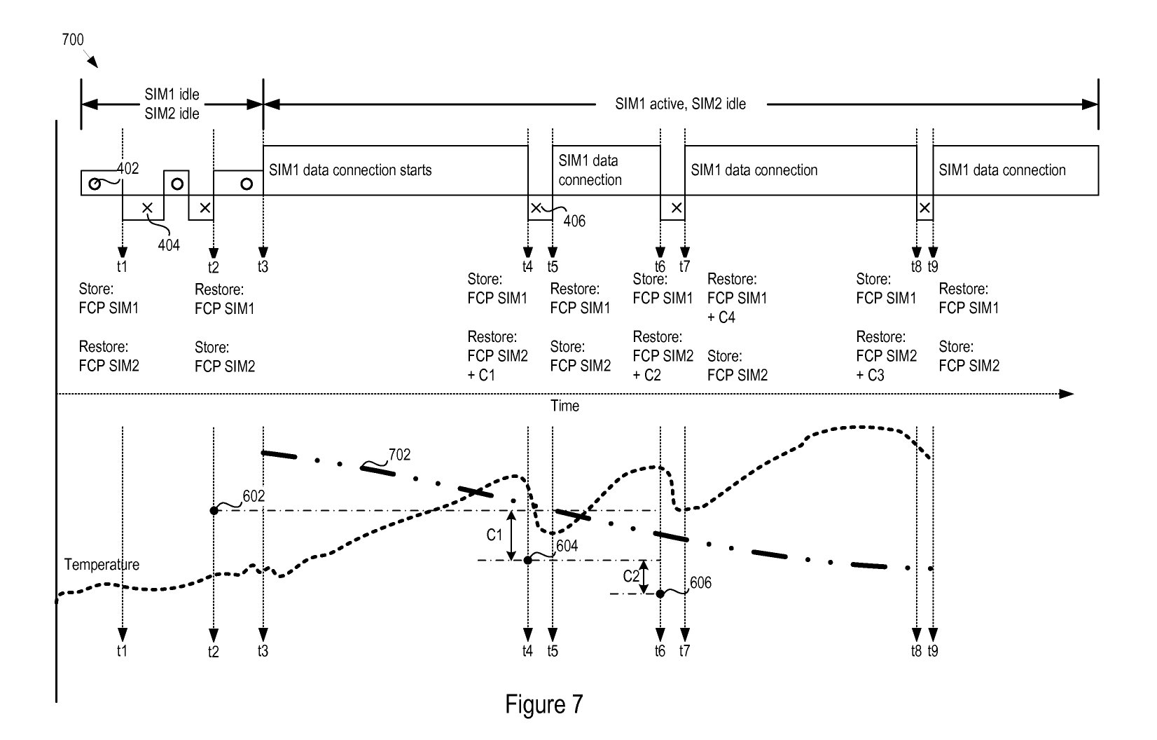

FIG. 7 shows that the frequency control instructions 122 may determine and apply time base corrections for SIM1 102 as well. An example is shown at time t7, with the time base correction C4 applied to a previously saved (e.g., at time t6) frequency control value for SIM1 102. FIG. 7 also shows that the frequency control instructions 122 may also make time base corrections while both SIMs are in idle mode. An example is shown at time t2, with the time base correction C5 applied to a previously saved frequency control parameter for SIM1 102 at time t2. The frequency control instructions 122 may determine and apply a similar correction to a previously saved frequency control parameter for SIM2 104, when the user equipment attempts to receive the paging indicator 404.

FIG. 7 also illustrates that during an active connection, such as the SIM1 data connection, the system logic 114 may adjust the DCXO 208 to keep the time base accurate for the active network connection. In particular, FIG. 7 shows a curve for a frequency control parameter 702 for the SIM1 data connection. Over time, as temperature rises, the system logic 114 adjusts the frequency control parameter 702 to keep the time base accurate with respect to the transmit and receive frequencies expected by the network handling the SIM1 network connection. Nevertheless, the adjusted frequency control parameter 702 for the SIM1 network connection will generally not be correct for setting the proper frequencies for the SIM2 network connection. Therefore, the system logic 114 monitors the environmental parameters as noted above and makes specific adjustments to the previously saved frequency control parameters for SIM2.

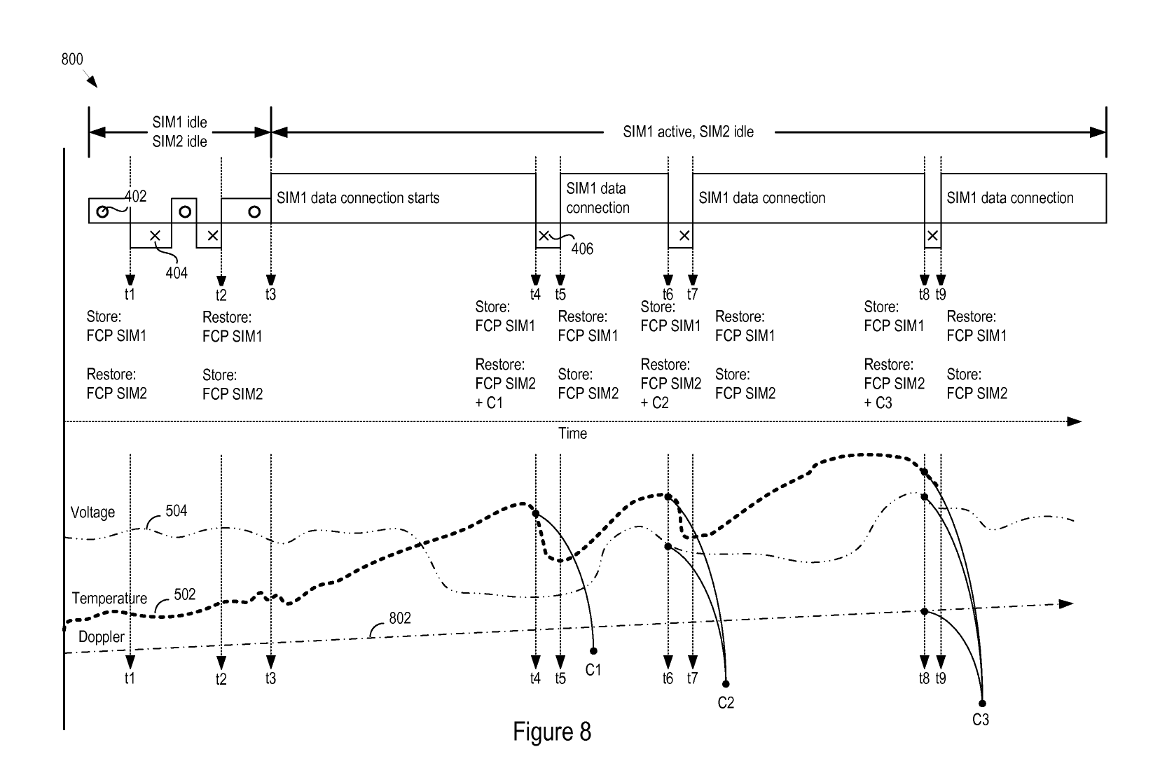

FIG. 8 shows an example 800 of determining correction values using a choice of parameters. As noted above the frequency control instructions 122 may determine a time base correction based any combination of environmental factors, not just on temperature alone. In FIG. 8, three environmental factors are represented: temperature 502, voltage 504, and Doppler shift 802 (e.g., the user equipment 100 may be a smart phone under acceleration in a car or train, causing increasing Doppler shift). At time t4, the frequency control instructions 122 consider changes in temperature 502 in determining the time base correction. At time t6, the frequency control instructions 122 consider changes in temperature 502 and voltage 504 in determining a time base correction. At time t8, the frequency control instructions 122 consider changes in temperature 502, voltage 504, and Doppler shift 802 in determining a time base correction. The frequency control instructions 122 may consider any combination of one or more environmental characteristics for determining a time base correction at any given time.

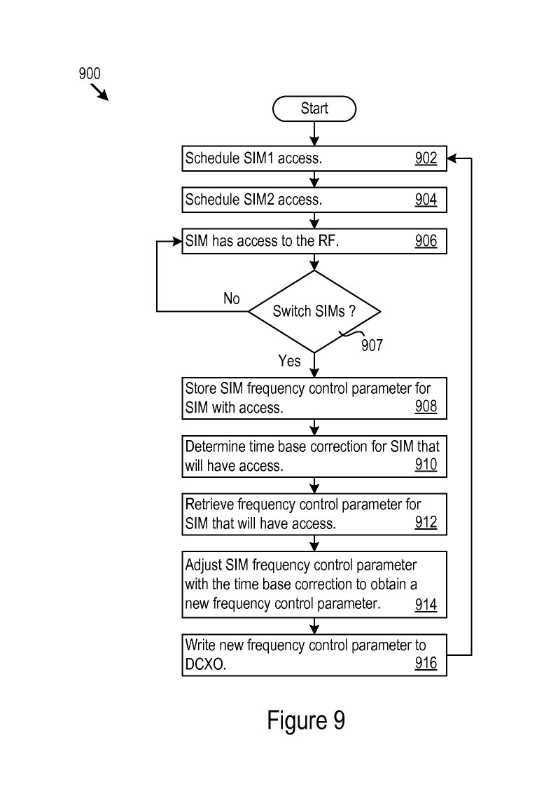

FIG. 9 is an example of logic 900 that the system logic 114 may implement, e.g., in the frequency control instructions 122 and RF scheduler 124. The logic 900 schedules SIM1 access (902) and SIM2 access (904). The access may be time division access, and the access may include checking for paging indicators while any or all SIMs are idle or are active. Examples are shown in FIGS. 4-7. Either SIM may have access to the RF at any given time (906).

The logic 900 determines when access switches from an active SIM to an inactive SIM (907). Such a switch may occur, for example, when SIM2 104 has an active network connection for a voice or data call, and when the RF scheduler 124 has scheduled an interruption to the network connection for SIM2 104 to attempt to receive paging indicators for SIM1 102. Before switching to the inactive SIM, the logic 900 stores the frequency control parameter for the SIM with access to the RF (908). As described above, the frequency control instructions 122 determine a time base correction for the SIM that will have access (910). Furthermore, the logic 900 retrieves a previously saved frequency control parameter for the SIM that will have access (912) and adjusts the frequency control parameter with the time base correction to obtain a new frequency control parameter (914). The new frequency control parameter may include changes to a coarse tuning register 212, a fine tuning register 210, or any other frequency control logic.

The frequency control instructions 122 write the new control parameter to the DCXO 208 (916). As a result, the receive (and transmit) frequencies change to the appropriate values to receive (and transmit) data for the network that supports the SIM that will have access to the RF. As such, the user equipment 100 may, for example, receive paging indicators for SIM1 (to continue the example above). As access switches between the SIMs, the logic 900 saves frequency control parameters and retrieves and adjusts previously saved frequency control parameters. The adjusted frequency control parameters greatly facilitate correct reception of data such as paging indicators. After the data is received, any already scheduled SIM network connection may continue. For example, the user equipment 100 may restore the frequency settings for the network supporting SIM2 104, and continue to send and receive data for the established SIM2 data or voice connection that was interrupted to receive the SIM1 102 paging indicators.

The methods, devices, techniques, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The RF scheduler 124 or other logic in the user equipment 100 may implement one or more Virtual Modems (VM) to coordinate access of the SIMs to the RF. A VM may refer to a software implementation of physical resources of the user equipment 100, for example through hardware virtualization. As described above with respect to the communication interface 112, the user equipment 100 may include one or more sets of physical baseband or RF resources, such as coders/decoders, modulators, amplifiers, and antennas. A VM may represent a software virtualization of any of the resources in the RF path in the communication interface 112. Accordingly, each SIM of the user equipment 100 may be assigned a VM, and thus recognize and use the virtualized communication resources of the VM to communicate across a network, without the need to understand or deal with the complexities that may arise from sharing RF path hardware between multiple SIMs. A separate VM may be instantiated and assigned to each SIM to communicate across a network associated with a respective SIM. Said another way, multiple VMs may share a common set of physical communication resources of the user equipment 100, with the VMs managed and controlled by VM logic, such as a virtual machine controller, which may be implemented in hardware, software, or both. The VM logic, as one example, may schedule or otherwise manage access to the RF path hardware for each SIM, as well as respond to requests made by the VMs for access to the RF path resources for their particular SIM.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method comprising:
when a first network connection is made for a first subscriber identity module (SIM), monitoring an environmental factor that influences time base accuracy; and
for receiving a paging indicator for a second SIM that is inactive:
determining a time base correction from the environmental factor; and
adjusting a time base by the time base correction for receiving the paging indicator for the second SIM.

2. The method of claim 1, further comprising:
interrupting the first network connection to attempt to receive the paging indicator for the second SIM.

3. The method of claim 1, further comprising:
retrieving a previously saved time base frequency control parameter for the second SIM.

4. The method of claim 3, further comprising:
adjusting the previously saved time based frequency control parameter by the time base correction.

5. The method of claim 1, where the time base correction comprises a coarse time base correction and a fine time base correction.

6. The method of claim 6, further comprising:
writing the coarse time base correction into a coarse adjustment control register; and
writing the fine time base correction into a fine adjustment control register.

7. The method of claim 1, where the environmental factor comprises temperature.

8. A system comprising:
an adjustable time base; and
frequency control logic in communication with the adjustable time base, the frequency control logic configured to:
obtain a time base correction;
determine when to interrupt a network connection for an active SIM in order to attempt to receive data for an inactive SIM;
obtain a previously saved time base frequency control parameter for the inactive SIM;
obtain a new time base control parameter from the previously saved time base frequency control parameter and the time base correction; and
set the adjustable time base to use the new time base control parameter.

9. The system of claim 8, where the frequency control logic is configured to:
obtain the time base correction based on a temperature measurement.

10. The system of claim 8, where the data for the inactive SIM comprises a paging indicator.

11. The system of claim 8, where the previously saved time base frequency control parameter comprises a time base setting for the second SIM that causes the time base to receive on a network frequency assigned to the second SIM.

12. The system of claim 8, where the frequency control logic is further configured to:
set the adjustable time base by setting a frequency control register.

13. The system of claim 12, where the frequency control register comprises a coarse frequency control register.

14. The system of claim 12, where the frequency control register comprises a fine frequency control register.

15. A system comprising:
radio frequency (RF) control logic comprising:
an oscillator frequency adjustment register;
a RF receive path configured to receive RF signals on a frequency responsive to the oscillator frequency adjustment register; and
baseband control logic comprising:
a communication interface to the radio frequency control section
a processor; and
a memory in communication with the processor, the memory comprising frequency control instructions configured to:
monitor an environmental parameter while a first SIM network connection is established for an active SIM;
determine a time base correction from the environmental parameter;
obtain a previously saved time base frequency control parameter;
obtain a new time base control parameter from the previously saved time base frequency control parameter and the time base correction; and
communicate the new time base control parameter to the RF control logic through the communication interface prior to an attempt to receive data for an inactive SIM.

16. The system of claim 15, where the data comprises a paging indicator.

17. The system of claim 15, where the first SIM network connection comprises a packet switched data connection.

18. The system of claim 15, where the environmental parameter comprises temperature.

19. The system of claim 18, where the memory further comprises:
a temperature-frequency response characteristic for an oscillator connected to the RF control logic; and where:
the frequency control instructions determine the time base correction by locating the temperature on the temperature-frequency response characteristic.

20. The system according to claim 15, where the frequency control instructions are further configured to:
save the new time base control parameter prior to continuing communication on the first SIM network connection; and
on a subsequent interruption of the first SIM network connection to attempt to receive data for the inactive SIM, retrieve the new time base control parameter for use as the previously saved time base frequency control parameter.
